(19) United States
(12) Patent Application Publication
(10) Pub. No.: US 2018/0058311 A1
(43) Pub. Date: Mar. 1, 2018

(54) TURBO COMPOUND SYSTEM FOR VEHICLE AND METHOD OF CONTROLLING THE SAME

(71) Applicant: Hyundai Motor Company, Seoul (KR)

(72) Inventor: Dong Hyuk CHOI, Seoul (KR)

(73) Assignee: Hyundai Motor Company, Seoul (KR)

(21) Appl. No.: 15/372,657

(22) Filed: Dec. 8, 2016

(30) Foreign Application Priority Data
Aug. 25, 2016 (KR) 10-2016-0108050

(51) Int. Cl. F02B 41/10; F02B 37/00

(52) U.S. Cl. CPC F02B 41/10; F02B 37/00

(57) ABSTRACT

A turbo compound system may include a blowdown turbine disposed at an exhaust gas outlet of a turbocharger turbine, a driveline connecting the blowdown turbine to the crankshaft of the engine to transmit power, an exhaust gas distributor disposed between the turbocharger turbine, a motor auxiliary device connected to the driveline to transmit power, the motor auxiliary device generating rotational force and transmitting the rotational force to a crankshaft of the engine through the driveline to assist output of the engine, and a controller controlling operation of the exhaust gas distributor and the motor auxiliary device.

### CROSS-REFERENCE TO RELATED APPLICATION

The present application claims priority to Korean Patent Application No. 10-2016-0108050, filed on Aug. 25, 2016 in the Korean Intellectual Property Office, the entire contents of which is incorporated herein for all purposes by this reference.

### BACKGROUND OF THE INVENTION

### Field of the Invention

The present invention relates to a turbo compound system for a vehicle and a method of controlling the same, more particularly, to a turbo compound system for a vehicle improving engine efficiency in which the turbo compound system does not function as resistance under a condition of engine operation in which the turbo compound system is capable of functioning as resistance, and a method of controlling the same.

### Description of Related Art

Research on a turbo compound system collecting waste energy thrown away from vehicles such as exhaust gas discharged upon operation of an engine to regenerate electrical energy or mechanical energy is continuously carried out.

The turbo compound system is a system for collecting kinetic energy of exhaust gas discharged from the engine of the vehicle. A blowdown turbine may be additionally mounted to collect kinetic energy of exhaust gas besides a turbocharger turbine used for suction supercharge. Energy collected at the blowdown turbine may be electrically or mechanically applied to available places in the vehicle.

Hereinafter, a configuration of the turbo compound system and a method of operating the same will be described in detail.

FIG. 1 is a view schematically illustrating a configuration of a turbo compound system.

In FIG. 1, reference numeral 11 denotes a turbocharger turbine converting energy of exhaust gas of an engine 10 into mechanical work. The turbocharger turbine 11 is connected to a compressor 12 via a coaxial shaft.

In addition, a blowdown turbine 13 is disposed at a side of an exhaust outlet of the turbocharger turbine 11.

Herein, the blowdown turbine 13 is connected to a crankshaft 21 of the engine 10 through a driveline to transmit power. The driveline includes a gearing unit 15 having deceleration function. The blowdown turbine 13 is connected to the crankshaft 21 of the engine 10 through the gearing unit 15 to transmit power.

In detail, a first reduction gear 16 is mounted at a turbine shaft 14 of the blowdown turbine 13. The first reduction gear 16 is engaged with a second reduction gear 17 and the second reduction gear 17 is connected to an output gear 19 via a shaft 18.

Furthermore, the output gear 19 is engaged with a crankshaft gear 22 mounted at the crankshaft 21.

Accordingly, when the engine 10 is driven, exhaust gas discharged from the engine 10 rotates the turbocharger turbine 11 while the compressor 12 connected to the turbocharger turbine 11 via the coaxial shaft is rotated. At this time, the compressor 12 as a sucker for burning of fuel compresses ambient air in order to supercharge the compressed air to the engine 10.

At the same time, exhaust gas driving the turbocharger turbine 11 is discharged to the blowdown turbine 13 to rotate the blowdown turbine 13.

Herein, rotational force of the blowdown turbine 13 is transmitted to the crankshaft 21 of the engine 10 through the gearing unit 15 and the crankshaft gear 22, thereby increasing output of the engine 10 without additional fuel consumption.

However, in the entire operation section of the engine 10, all exhaust gas passes through the turbo compound system including the turbocharger turbine 11 and the blowdown turbine 13 such that engine efficiency is reduced under a condition of engine operation in which the turbo compound system functions as resistance.

Referring to FIG. 2, in a main operating section having an engine torque or an engine revolution per minute with respect to fuel amount, i.e., 500 to 2500 rpm, of the entire operation section of the engine (entire load section), engine efficiency is increased by operation of the turbo compound system (engine rpm of the main operating section may change depending on grades of an engine). However, in the remaining operation section of the engine outside the main operating section, engine efficiency may be decreased because the turbo compound system functions as resistance.

For example, in a conventional turbo compound engine, in the entire operation section of the engine 10, since exhaust gas passes through a turbo compound system, particularly, the blowdown turbine 13, the crankshaft gear 22 rotates the output gear 19 in a low speed/low load section where rotational speed of the turbo compound system (the blowdown turbine 13) is low, thereby decreasing engine efficiency.

The reason why the turbo compound system functions as resistance in the remaining operation section outside the main operating section of the entire operation section of the engine 10 is that the turbo compound system is developed to have optimizing effect in the main operating section of the entire operation section of the engine 10.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a turbo compound system for a vehicle improving engine efficiency in which the turbo compound system does not function as resistance under a condition of engine operation in which the turbo compound system is capable of functioning as resistance, and a method of controlling the same.

In accordance with one aspect of the present invention, the above and other objects can be accomplished by the provision of turbo compound system for a vehicle including a blowdown turbine disposed at an exhaust gas outlet of a turbocharger turbine to be rotated by exhaust gas of an engine passing through the turbocharger turbine, a driveline connecting the blowdown turbine to the crankshaft of the engine to transmit power, an exhaust gas distributor disposed between the turbocharger turbine and the blowdown turbine to adjust the amount of exhaust gas supplied to the blowdown turbine, a motor auxiliary device connected to the driveline to transmit power, the motor auxiliary device generating rotational force and transmitting the rotational force to the crankshaft of the engine through the driveline to assist output of the engine, and a controller controlling operation of the exhaust gas distributor and the motor auxiliary device.

In accordance with another aspect of the present invention, a method of controlling a turbo compound system for a vehicle including rotating a turbocharger turbine by exhaust gas of an engine, determining whether an engine operation section corresponds to a predetermined operation section in which the turbo compound system functions as resistance, reducing or blocking exhaust gas introduced to a blowdown turbine after passing through the turbocharger turbine using an exhaust gas distributor when corresponding to the predetermined operation section in which the turbo compound system functions as resistance, blocking power between the blowdown turbine and a crankshaft of the engine by control of a driveline between the blowdown turbine and the crankshaft of the engine, and assisting engine output by transmission of rotational force generated at a motor auxiliary device to the crankshaft of the engine via the driveline using the motor auxiliary device.

Other aspects and exemplary embodiments of the invention are discussed infra.

It is understood that the terms “vehicle”, “vehicular” and other similar terms as used herein are inclusive of motor vehicles in general including passenger automobiles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain predetermined principles of the present invention.

### BRIEF DESCRIPTION OF THE DRAWINGS

FIG. 1 is a schematic diagram illustrating a configuration of the conventional turbo compound system;

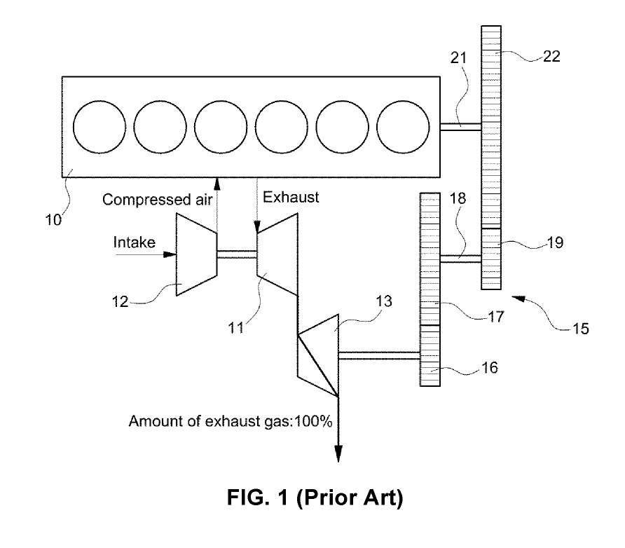

FIG. 2 is a graph illustrating an operation section of an engine including the conventional turbo compound system and efficiency thereof;

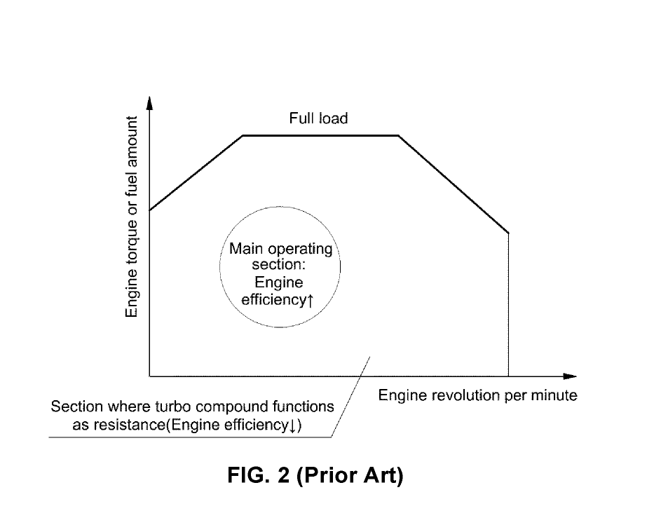

FIG. 3 is a schematic diagram illustrating a configuration of a turbo compound system according to an exemplary embodiment of the present invention; and

FIG. 4 is a flowchart performed by a controller and illustrating a controlling state of the turbo compound system according to the exemplary embodiment of the present invention.

It may be understood that the appended drawings are not necessarily to scale, presenting a somewhat simplified representation of various exemplary features illustrative of the predetermined principles of the invention. The specific design features of the present invention as included herein, including, for example, specific dimensions, orientations, locations, and shapes will be determined in part by the intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Unless explicitly stated to the contrary, the word “comprise,” “comprises” or “comprising” used throughout the specification will not be understood as the exclusion of the other elements but to imply the inclusion of the other elements.

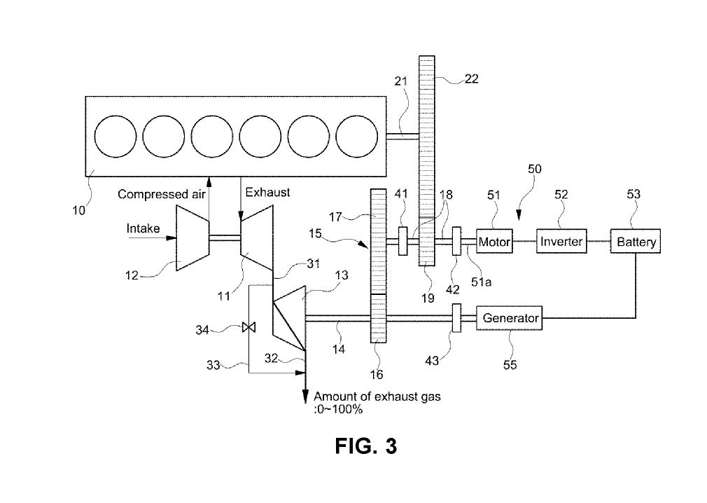

FIG. 3 is a schematic diagram illustrating a configuration of a turbo compound system according to an exemplary embodiment of the present invention.

As illustrated, a turbocharger turbine 11 converting exhaust gas energy of an engine 10 into mechanical work is connected to a compressor 12 via a coaxial shaft. A blowdown turbine 13 is disposed at an exhaust gas outlet of the turbocharger turbine 11.

Herein, the blowdown turbine 13 is connected to a crankshaft 21 of the engine 10 via a driveline to transmit power. The driveline includes a gearing device 15 having deceleration function and clutches 41, 42, and 43, which will be explained. The blowdown turbine 13 is connected to the crankshaft 21 of the engine 10 via the gearing device 15 to transmit power.

The gearing device 15 is connected to the blowdown turbine 13 and the crankshaft 21 of the engine 10 to transmit power while configured to connect the motor auxiliary device 50 and the crankshaft 21 of the engine 10 to transmit power.

Hereinafter, the gearing device 15 will be explained in detail. A first reduction gear 16 is mounted at a turbine shaft 14 of the blowdown turbine 13. A second reduction gear 17 is engaged with the first reduction gear 16 and is connected to an output gear 19 via a shaft 18.

Furthermore, the output gear 19 is engaged with a crankshaft gear 22 mounted at the crankshaft 21.

Accordingly, when the engine 10 is operated, exhaust gas discharged from the engine 10 rotates the turbocharger turbine 11 while a compressor 12 connected to the turbocharger turbine 11 via the coaxial shaft is rotated. Herein, the compressor 12 as a suction device for burning of fuel compresses ambient air to supercharge the compressed air to the engine 10.

At the same time, exhaust gas driving the turbocharger turbine 11 is discharged to the blowdown turbine 13 to rotate the blowdown turbine 13.

When the blowdown turbine 13 is rotated, rotational force of the blowdown turbine 13 is transmitted via the first reduction gear 16 and the second reduction gear 17 to rotate the output gear 19. Rotational force output via the output gear 19 is transmitted to the crankshaft 21 via the crankshaft gear 22 to assist output of the engine 10.

Meanwhile, the turbo compound system according to the exemplary embodiment of the present invention includes an exhaust gas distributor mounted between the turbocharger turbine 11 and the blowdown turbine 13 to adjust the amount of exhaust gas flowing to the blowdown turbine 13.

The exhaust gas distributor includes a bypass path 33 for preventing exhaust gas from being introduced to the blowdown turbine 13 while exhaust gas is bypassed, and a bypass valve 34 mounted on the bypass path 33.

That is, the bypass path 33 is connected between an inlet side exhaust gas path 31 connected between an outlet of the turbocharger turbine 11 and an inlet of the blowdown turbine 13, and an outlet side exhaust gas path 32 connected to an outlet of the blowdown turbine 13. The bypass valve 34 is mounted at the bypass path 33 to open/close the bypass path 33 and to adjust opening degree of the bypass path 33.

The bypass valve 34 performs opening or closing operation according to a signal of a controller while adjusting the opening degree of the bypass path 33. An electronic valve is used as the bypass valve 34.

Herein, although not shown in the drawings, a separate opening/closing valve may be mounted at a downstream side of a point diverged from the bypass path 33 in the inlet side exhaust gas path 31 of the blowdown turbine 13. An electronic valve performing opening or closing operation according to a signal of a controller is used as the opening/closing valve.

Furthermore, a first clutch 41 is mounted between the blowdown turbine 13 and the engine crankshaft 21 to selectively transmit or block power. In an embodiment, the first clutch 41 may be mounted between the second reduction gear 17 and the output gear 19. In detail, the first clutch 41 may be mounted at an output shaft 18 at which the gears are mounted to transmit and block power between the second reduction gear 17 and the output gear 19.

In addition, the turbo compound system includes the motor auxiliary device 50 to supply auxiliary power to the engine 10. The motor auxiliary device 50 includes a motor 51 generating power (rotational force), an inverter 52 actuating the motor 51, and a battery 53 functioning as a motor actuating power.

The motor 51 is connected to the engine 10 to supply power to the crankshaft 21. A second clutch 42 is interposed between the engine 10 and the motor 51 to selectively transmit or block power.

In an embodiment, the motor 51 may be connected to the engine 10 via the gearing device 15 to transmit power. In detail, the motor 51 is connected to the output gear 19 to transmit power, while a drive shaft 51a of the motor 51 may be connected to the output shaft 18, in which the output gear 19 is mounted, to transmit power.

Furthermore, the drive shaft 51a of the motor 51 may be connected to the output shaft 18 of the turbo compound system, and the second clutch 42 is interposed between the drive shaft 51a and the output shaft 18.

The motor 51 is connected to the battery 53 via the inverter 52. The inverter 52 converts direct current into three-phase current to be applied to the motor 51, actuating the motor 51.

In addition, the motor auxiliary device 50 further includes a generator 55 connected to the turbine shaft 14 of the blowdown turbine 13 to selectively transmit power. The generator 55 is connected to the battery 53.

Accordingly, when the blowdown turbine 13 rotates, the generator 55 receives rotational force generated from the blowdown turbine 13 to generate power. Electric energy generated by the generator 55 may be stored in the battery 53.

In addition, the motor 51 of the motor auxiliary device 50 is driven by electric energy stored in the battery 53 after being generated by the generator 55.

A third clutch 43 is mounted at the turbine shaft 14. The third clutch 43 is connected or separated between the blowdown turbine 13 and the generator 55 to selectively transmit power.

Operation of the first clutch 41, the second clutch 42, and the third clutch 43 is controlled by the controller. Each clutch is controlled by a control signal output from the controller to be a coupled state for transmitting power or an uncoupled state for not transmitting power.

Furthermore, the controller controls actuation of the motor 51 via the inverter 52.

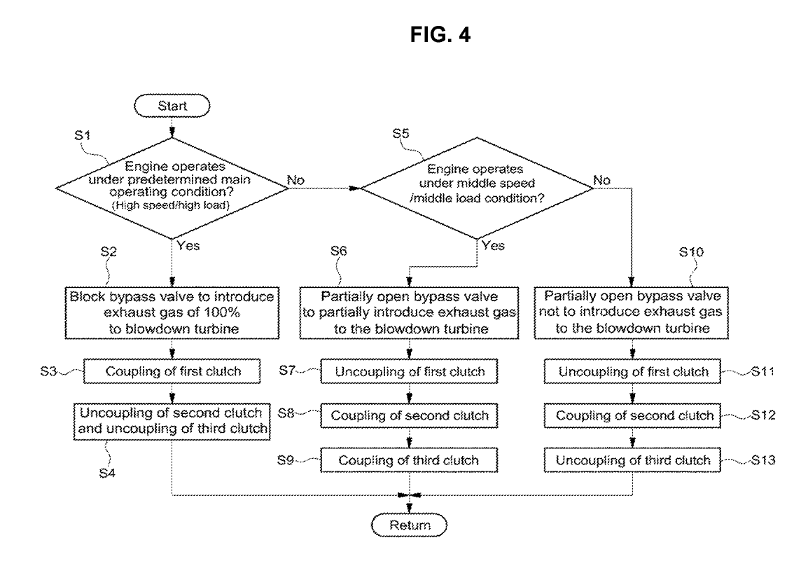

Hereinafter, a method of controlling the turbo compound system including the motor auxiliary device with reference to FIG. 4 will be explained.

First, in an engine operation section (a middle speed or middle load section, a high speed or high load section) where the turbo compound system functions as resistance, auxiliary power is supplied to the engine 10 through the separate motor auxiliary device.

Furthermore, under the middle speed or middle load condition or a low speed or low load condition, namely, when the amount of exhaust gas is small, some exhaust gas or all of the exhaust gas introduced to the blowdown turbine 13 is blocked. The gearing device 15 and the crankshaft gear 22 of the turbine compound system are uncoupled using the first clutch 41.

As a result, in an operation section in which the turbo compound system functions as resistance, reduction of engine efficiency may be improved.

Furthermore, in the middle speed/middle load or the low speed/low load condition, the motor auxiliary device 50 is connected to the gearing device 15 to charge the battery 53 via the generator 55, or auxiliary power is supplied to the engine 10 through the motor 51, improving engine efficiency and fuel efficiency.

Referring to FIG. 4, the controller determines whether the engine 10 is operated at the predetermined main operating condition (high speed/high load) of the entire operation section of the engine 10.

Namely, the controller determines whether the engine 10 is operated under the high speed condition which is over a first predetermined speed or under the high load condition which is over a first predetermined load (S1). Herein, when the engine 10 is operated under the high speed/high load condition, the controller closes the bypass valve 34 to block the bypass path 33. Thus, exhaust gas of 100% is introduced to the turbo compound system, The blowdown turbine 13 of the turbo compound system (S2).

Herein, the controller allows coupling of the first clutch 41 (S3) such that the gear device 15 (the second reduction gear 17) of the turbo compound system is connected to the crankshaft gear 22 and the crankshaft 21 to transmit power. At the same time, the second clutch 42 between the engine 10 (the crankshaft 21) and the motor 51 is uncoupled while the third clutch 43 between the blowdown turbine 13 (the turbine shaft 14 and the first reduction gear 16) and the generator 55 is uncoupled (S3).

As a result, the blowdown turbine 13 is rotated by exhaust gas discharged from the engine 10. Rotational force of the blowdown turbine 13 is transmitted to the crankshaft 21 via the gearing device 15 and the crankshaft gear 22, assisting output of engine 10.

Meanwhile, when the engine 10 is operated under the middle speed/middle load condition rather than the high speed/high load condition, namely, when the engine 10 is operated under the middle speed condition which is equal to or less than the first predetermined speed while being within a predetermined speed range or under the middle load condition which is equal to or less than the first predetermined load while being within a predetermined load range, the controller allows the bypass valve 34 to be partially opened at the predetermined amount to bypass some exhaust gas via the bypass path 33 without the blowdown turbine 13 (S5 and S6) and to introduce the remaining exhaust gas to the blowdown turbine 13.

Alternatively, when the engine 10 is operated under the low speed/low load condition, namely, when the engine is operated under the low speed condition which is less than the predetermined speed range (namely, less than a second predetermined speed) or under the low load condition which is less than the predetermined load range (namely, less than a second predetermined load), the controller allows the bypass valve 34 to be completely opened to bypass all exhaust gas via the bypass path 33 without the blowdown turbine 13 (S5 and S10).

Herein, when the separate opening/closing valve is mounted at the inlet exhaust gas path 31 of the blowdown turbine 13, the controller allows the opening/closing valve to be completely closed, preventing exhaust gas from being introduced to the blowdown turbine 13.

When the engine 10 is operated under the high speed/high load condition and the middle speed/middle load condition, the controller completely opens the opening/closing valve.

In addition, in the middle speed/middle load condition and the low speed/low load condition, the controller allows the first clutch 41 to be uncoupled and allows the second clutch 42 to be coupled. (S7, S8, S11, and S12)

Furthermore, in the middle speed/middle load condition, the controller allows the third clutch 43 to be coupled (S9). In the low speed/low load condition, the controller allows the third clutch 43 to be uncoupled (S13).

Accordingly, in the middle speed/middle load condition, some exhaust gas is introduced to the blowdown turbine 13 to rotate the blowdown turbine 13.

Herein, the motor 51 is connected to the engine 10 and the crankshaft 21 by coupling of the second clutch 42. The controller allows the motor 51 to be actuated such that the motor 51 assists output of the engine 10.

Furthermore, the blowdown turbine 13 is connected to the generator 55 by coupling of the third clutch 43. Rotational force of the blowdown turbine 13 is transmitted to the generator 55.

Herein, rotational force of the blowdown turbine 13 is not transmitted to the crankshaft 21 but is transmitted to the generator 55, by uncoupling of the first clutch 41. Accordingly, electric energy is generated by operation of the generator 55 while generated electric energy is transmitted to the battery 53 to be charged.

Meanwhile, in the low speed/low load condition, all exhaust gas is not introduced to the blowdown turbine 13 and is bypassed via the bypass path 33. The motor 51 is connected to the engine 10 and the crankshaft 21 by coupling of the second clutch 42.

Herein, the controller allows the motor 51 to be actuated such that the motor assists output of the engine 10. The blowdown turbine 13 and the generator 55 are in uncoupling state by uncoupling of the third clutch 43.

Thus, in the high speed/high load condition, exhaust gas of 100% is supplied to the blowdown turbine 13 to rotate the blowdown turbine 13. Herein, the blowdown turbine 13 is connected to the engine 10 side to transmit power such that rotational force of the blowdown turbine 13 is transmitted to the crankshaft gear 22 and the crankshaft 21. Accordingly, the turbo compound system assists output of the engine 10.

Meanwhile, in the middle speed/middle load condition, the bypass valve 34 is partially opened such that some exhaust gas is supplied to the blowdown turbine 13. Herein, the motor 51 is connected to the engine 10 side to transmit power while the blowdown turbine 13 is connected to the generator 55 to transmit power.

Thus, the motor 51 assists output of the engine 10, rotational force of the blowdown turbine 13 is transmitted to the generator 55, and the generator 55 generates power to charge the battery 53. Accordingly, the turbo compound system is used to charge the battery 53.

Furthermore, in the low speed/low load condition, the motor 51 is connected to the engine 10 side to transmit power such that the motor assists output of the engine. At the same time, the bypass valve 34 is completely opened such that all exhaust gas is bypassed through the bypass path 33 without the blowdown turbine 13. Accordingly, the turbo compound system does not function as exhaust resistance to improve engine efficiency.

As apparent from the above description, in accordance with the present invention, there are advantages as below.

First, in a condition of engine operation in which the turbo compound system is capable of functioning as resistance, the amount of exhaust gas introduced to the blowdown turbine of the turbo compound system is reduced or is controlled to be blocked, such that the turbo compound system does not function as resistance. As a result, engine efficiency is improved.

Second, in a condition of engine operation in which the turbo compound system is capable of functioning as resistance, the amount of exhaust gas introduced to the blowdown turbine of the turbo compound system is reduced or is controlled to be blocked while the clutch between the turbo compound system and the engine crankshaft is released to block power transmission. Accordingly, it is possible to prevent the turbo compound system from functioning as resistance, improving engine efficiency.

Third, the motor auxiliary device connected to the engine to selectively transmit power is provided. When the amount of exhaust gas introduced to the blowdown turbine of the turbo compound system is reduced or is controlled to be blocked, the motor auxiliary device supplies auxiliary power, increasing engine output.

Fourth, the clutch between the blowdown turbine and the engine is released such that power transmission is blocked. Herein, rotational force of the blowdown turbine is used as power for operation of the generator to charge the battery. Accordingly, kinetic energy of exhaust gas may be collected as electric energy.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbo compound system for a vehicle comprising:
a blowdown turbine disposed at an exhaust gas outlet of a turbocharger turbine to be rotated by exhaust gas of an engine passing through the turbocharger turbine;
a driveline connecting the blowdown turbine to a crankshaft of the engine to transmit power;
an exhaust gas distributor disposed between the turbocharger turbine and the blowdown turbine to control an amount of exhaust gas supplied to the blowdown turbine;
a motor auxiliary device connected to the driveline to transmit power, the motor auxiliary device generating rotational force and transmitting the rotational force to the crankshaft of the engine through the driveline to assist output of the engine; and
a controller controlling operation of the exhaust gas distributor and the motor auxiliary device.

2. The turbo compound system according to claim 1, wherein the driveline includes:
a first clutch operating according to a signal of the controller, the first clutch transmitting or blocking power between the blowdown turbine and the crankshaft of the engine; and
a second clutch operating according to a signal of the controller, the second clutch transmitting or blocking power between the motor auxiliary device and the crankshaft of the engine.

3. The turbo compound system according to claim 2, wherein the driveline further includes a gearing device disposed between a turbine shaft of the blowdown turbine and a crankshaft gear mounted at the crankshaft of the engine, and
wherein a motor drive shaft outputting rotational force of a motor to assist engine output is connected to the gearing device with the second clutch.

4. The turbo compound system according to claim 3, wherein the gearing device includes:
a first reduction gear mounted at the turbine shaft of the blowdown turbine;
a second reduction gear engaged with the first reduction gear; and
an output gear connected to the second reduction gear via an output shaft, the output gear being engaged with the crankshaft gear,
wherein the first clutch is mounted on the output shaft connected between the second reduction gear and the output gear.

5. The turbo compound system according to claim 1, wherein the motor auxiliary device includes:
a motor generating and outputting rotational force to assist engine output;
an inverter for driving the motor according to a signal of the controller; and
a battery supplying power for driving the motor via the inverter.

6. The turbo compound system according to claim 5, wherein the motor auxiliary device further includes a generator receiving rotational force from the blowdown turbine to generate power, the generator charging the battery; and
the driveline further includes a third clutch operating according to a signal of the controller, the third clutch transmitting or blocking power between the blowdown turbine and the generator.

7. The turbo compound system according to claim 1, wherein the exhaust gas distributor includes:
a bypass path mounted to be connected between an inlet side exhaust gas path and an output side exhaust gas path of the blowdown turbine to bypass exhaust gas, wherein exhaust gas is not introduced into the blowdown turbine; and
a bypass valve mounted at the bypass path.

8. A method of controlling a turbo compound system for a vehicle comprising:
rotating a turbocharger turbine by exhaust gas of an engine;
determining whether an engine operation section corresponds to a predetermined operation section in which the turbo compound system functions as resistance;
reducing or blocking exhaust gas introduced to a blowdown turbine after passing through the turbocharger turbine using an exhaust gas distributor when corresponding to the predetermined operation section in which the turbo compound system functions as resistance;
blocking power between the blowdown turbine and a crankshaft of the engine by control of a driveline between the blowdown turbine and the crankshaft of the engine; and
assisting engine output by transmission of rotational force generated at a motor auxiliary device to the crankshaft of the engine via the driveline using the motor auxiliary device.

9. The method of controlling the turbo compound system according to claim 8, wherein the predetermined operation section in which the turbo compound system functions as resistance includes a middle speed or a middle load section in which the engine is configured to be operated under a middle speed condition within a predetermined speed range or under a middle load condition within a predetermined load range, and
in the middle speed or middle load section, an amount of exhaust gas introduced to the blowdown turbine via the turbocharger turbine is configured to be controlled to be reduced using the exhaust gas distributor.

10. The method of controlling the turbo compound system according to claim 9, wherein, in the middle speed or middle load section, the blowdown turbine is connected to a generator to transmit power by control of the driveline, and
the generator receives rotational force from the blowdown turbine to generate power and to charge a battery.

11. The method of controlling the turbo compound system according to claim 9, wherein, in a high speed or a high load section in which the engine is configured to be operated under a high speed condition over the predetermined speed range or under a high load condition over the predetermined load range,
all exhaust gas passing through the turbocharger turbine is introduced to the blowdown turbine using the exhaust gas distributor; and
power between the crankshaft of the engine and the motor auxiliary device is configured to be blocked by control of the driveline.

12. The method of controlling the turbo compound system according to claim 8, wherein the predetermined operation section in which the turbo compound system functions as resistance comprises a low speed or a low load section in which the engine is configured to be operated under a low speed condition below a predetermined speed or under a low load condition below a predetermined load, and
exhaust gas introduced to the blowdown turbine is configured to be blocked using the exhaust gas distributor in the low speed or the low load section.

13. The method of controlling the turbo compound system according to claim 8, wherein the driveline includes:
a first clutch transmitting or blocking power between the blowdown turbine and the crankshaft of the engine; and
a second clutch transmitting or blocking power between the motor auxiliary device and the crankshaft of the engine.

14. The method of controlling the turbo compound system according to claim 13, wherein the driveline further includes a gearing device mounted between a turbine shaft of the blowdown turbine and a crankshaft gear mounted at the crankshaft of the engine,
the gearing device is connected to a motor drive shaft in which the second clutch is mounted, and the motor drive shaft outputs rotational force of a motor to assist output of the engine at the motor auxiliary device.

15. The method of controlling the turbo compound system according to claim 8, wherein the motor auxiliary device includes:
a motor generating and outputting rotational force to assist output of the engine;
an inverter actuating the motor according to a signal of a controller; and
a battery applying power for operation to the motor via the inverter.

16. The method of controlling the turbo compound system according to claim 8, wherein the exhaust gas distributor includes:
a bypass path mounted to be connected between an inlet exhaust gas path and an outlet exhaust gas path to bypass exhaust gas so that exhaust gas is not introduced to the blowdown turbine; and
a bypass valve mounted at the bypass path.
